(19) United States
(12) Patent Application Publication
(10) Pub. No.: US 2006/0060722 A1
(43) Pub. Date: Mar. 23, 2006

(54) Controlling bondary layer fluid flow

(76) Inventors: Kwing-so Choi, Nottingham (GB); Nicolas Hutchins, Minneapolis, MN (US); Ho Chan, Busan (KR)

Correspondence Address: BAKER & BOTTS, 30 ROCKEFELLER PLAZA, NEW YORK, NY, 10112, US

(21) Appl. No.: 10/517,798

(22) PCT Filed: Jun. 13, 2003
(86) PCT No.: PCT/GB03/02548

§ 371 Date: Aug. 17, 2005

(30) Foreign Application Priority Data
Jun. 13, 2002 (GB) 0213551.5

(51) Int. Cl. B64C 21/10

(52) U.S. Cl. 244/200.1

(57) ABSTRACT

A method of controlling fluid flow (14) in a boundary layer at a fluid-surface interface comprising, providing a plurality of blades (11) which project from the fluid contracting surface into a boundary layer such that in use the blades (11) are orientated to control fluid flow (14) in the boundary layer.

This invention relates to the control of fluid flow in a boundary layer at a fluid-surface interface, especially controlling turbulent flow.

The control of fluid flow in the boundary layer can have the effect of reducing, or increasing, friction or surface drag at a fluid-surface interface. In particular, the invention is concerned with the control of turbulent fluid flow in the boundary layer.

This invention has particular application at the fluid-surface interface of vehicles, in particular fluid craft, by which is meant any craft which moves through a fluid such as cars, road vehicles, trains, aircraft, watercraft, ships, underwater vessels, hovercraft, balloons; and in relation to pipes or conduits carrying air, oil or other fluids where the control of the fluid flow and attendant friction or surface drag is a concern. However, it can be applied to any situations where there is a fluid-surface interface, such as wind turbine blades, gas turbine blades or a swimsuit.

A boundary layer of fluid surrounds any solid body or surface which has relative movement in relation to a fluid with which it is in contact - such as, an aircraft in the air, or a pipe carrying gas or liquid. More specifically, the boundary layer is the layer of fluid between a surface and a main stream fluid flow over the surface. The relative velocity of the surface and fluid at the fluid-surface interface is zero. There is a transition of velocities through the boundary layer adjacent the surface as one moves away from the surface towards a main stream fluid flow, until the main stream fluid flow velocity is reached.

The nature of the fluid flow in the boundary layer determines the degree of surface friction or drag at the solid surface. Turbulent flow produces significant surface friction or drag, which can be more than twice as much as that when fluid flow at the boundary layer is laminar.

Whenever a body moves through a viscous medium, or indeed a viscous medium moves through or over a body, drag forces will reduce the mechanical efficiency of the system. Efficient operation of such systems, be they aircraft, hydrodynamic vehicles or pipelines, necessitates that these drag forces be as low as possible.

The total drag acting on a surface can be separated into the components pressure drag, induced drag and, for high mach numbers, wave drag. For streamlined bodies at subsonic speed, the major component of drag is due to skin friction.

In order to reduce drag or surface friction, say in an aircraft, it is desirable to reduce turbulent flow in the boundary layer and to encourage more laminar flow. The reduction of surface friction on the outer surface of an aircraft allows improved fuel efficiency, for example up to 50% of fuel burnt on a commercial airliner is used to overcome skin friction. The increased fuel efficiency may result in an increased passenger/cargo capacity, faster flights, and even the ability to use shorter runways, as well as a reduction in noise levels and structural fatigue. A balance between these advantages is usually struck.

A reduction in drag or surface friction can also be used to reduce heat transfer at the fluid-surface interface, protecting structures from extremes of temperature.

In other circumstances, it may be desirable to increase drag or surface friction. For example, some aircraft use devices known as vortex inducers or generators to increase lift during take-off.

Much research has been undertaken to address the manipulation of fluid flow in the boundary layer, in particular to reduce surface friction or drag in aircraft. This research can be broadly split into two areas, namely passive and active control. Passive techniques attempt to impose a broad-scale global control on the turbulent boundary layer without energy input, to obtain global skin friction reductions. Active control relies on sensing and then interacting with the turbulent fluid flow at a local level, the aim being to reduce local skin friction whilst possibly having broader effects on the global regenerative mechanism. Some prior art of which we are aware is listed below.

U.S. Pat. No. 4,706,910 (Walsh et al) describes a passive system of flow control which results in reduced skin friction on aerodynamic and hydrodynamic surfaces. Surface friction or drag is reduced by a combination of two devices, namely: (i) a series of ‘riblets’ or small, flow aligned ‘v’ micro-grooves with dimensions of 0.05 to 0.5 mm, intended to reduce disturbances in fluid flow near wall surfaces, in particular to reduce wall vortices and turbulent burst dimensions; and (ii) large eddy break up (LEBU) devices configured as small aerofoils or flat ribbons, parallel to or spanwise across the airflow, extending 50 to 80% of the thickness of the boundary layer, that is some 7.5 to 15 mm, intended to cause a disruption of the large scale vortices.

U.S. Pat. No. 5,848,769 (Fronek et al) and WO89/11343 (Choi) also describe surface friction or drag reducing devices configured as riblets.

Hefner, Weinstein & Bushnell (1979) Prog. Astronaut Aeronaut 72, 110-127 describe tests using 22.86 cm spanwise arrays of one, two or three horizontal elements, supported by four 7.62 cm vertical elements. No parametric analysis of the vertical elements was undertaken, which were considered to be provided only for support purpose.

Savill & Mumford (1988) J. Fluid Mech. 191, 389-418, describe studies using LEBU devices configured as horizontal elements extending parallel to the surface. They were tested at various heights and chords, stacked and in tandem.

Yajnik & Acharya (1977) in Structure and Mechanisms of Turbulence, Lecture Notes in Physics, vol: 76, 249-260, describe LEBU devices configured as small honeycomb fences of approximately boundary layer height, which result in a 50% c_{f} (skin friction) reduction. However, the net drag is observed to increase by several hundred percent.

LEBU devices have been applied to aircraft to reduce drag or surface friction during flight. Such devices are generally configured as small airfoils or horizontal devices, suspended from the aircraft outer frame, and extending parallel to the surface of the aircraft and orientated across the direction of fluid flow. Generally, LEBU devices are located near the edge of the boundary layer to disrupt the large eddies.

The requirement that LEBU devices are suspended from a surface results in problems of device rigidity and security. If configured as thin sheets LEBU devices tend to flutter if not sufficiently supported. However, the more supports introduced or any increase in device thickness will be to the detriment of device drag. Indeed at high Reynolds numbers the preferred design of LEBU devices switches to an aerofoil section (low drag, high stiffness structure), with associated complications due to sensitivity of profile shape, angle of attack and chord Re number.

The Reynolds (Re) number is defined as Re= Ux/v, where U is the flow speed, x is the length of the body and v is the kinematic viscosity of fluid. The Reynolds number of the boundary layer over the aircraft is ‘high’, compared to wind tunnel or laboratory experiments, because U (aircraft speed) and x (body length) are greater on an aircraft.

The chord Reynolds number is as described above except x is the chord length of the blades rather than the length of the body upon which the blades are located.

The UK Patent Office has undertaken a novelty search on the present invention and identified U.S. Pat. No. 5,988,568, DE 3534268, DE 3609541, U.S. Pat. Nos. 4,425,942, US 4,836,473, US 5,734,090 and GB 1034370 which in general relate to devices and methods for inducing vortex formation to allegedly reduce drag at a fluid surface interface.

Skin friction reductions have also been realised by injecting polymer chains into fluid flows to interrupt the near wall structures, or by injecting micro-bubbles into a liquid flow. Alternatively, skin friction may be reduced by oscillating the surface in a spanwise direction or even oscillating the flow in the spanwise direction, for example, using Lorenz force control of sea water.

According to an aspect of the present invention we provide a method of controlling fluid flow, in a boundary layer at a fluid-surface interface comprising: providing a plurality of blades which project from a fluid contacting surface into a boundary layer, such that in use the blades are orientated to control fluid flow in the boundary layer.

Preferably, the blades are self supporting.

In a preferred configuration the blades are orientated to straighten the fluid flow, and accordingly are orientated generally aligned with the direction of fluid flow. In this configuration the blades comprise flow manipulator blades which ‘comb’ and ‘straighten’ turbulent fluid flow in the boundary layer. As a result, fluid flow downstream of the blades is less turbulent, than it was upstream of the blades, and the friction or surface drag created by turbulent fluid at the fluid-surface interface is reduced, in comparison with the same surface without blades.

Alternatively, the blades may be orientated to induce turbulence or generate vortices in the fluid flow. More specifically, this may be achieved by orientating the blades, in particular those on the wing and/or stabilisers, at an angle across the direction of fluid flow to induce turbulence or vortices in the fluid flow. This may increase surface friction or drag at the surface.

In a preferred method the blades are applied to the fluid contacting surface of a vehicle, such as an aircraft, or the fluid contacting surface of a fluid carrying conduit, such as a pipe.

Preferably a reduction in surface drag or friction will reduce aerodynamic noise and reduce structural fatigue as well as realising a weight saving. Typically, heat transfer will result as a consequence of reduced surface friction or drag thus affording structures/surfaces to which the blades are applied some protection from extremes of temperature. Preferably an at least 2%, 5%, 10% or 15% improvement in reduction of surface drag; reduction of noise levels; reduction of fuel consumption; or increased speed; is observed compared to vehicle, including an a aircraft, without flow manipulator blades projecting from the fluid contacting surface.

At least one hundred blades may be used. Alternatively at least one thousand blades may be used. Alternatively, at least ten thousand blades may be used.

According to a further aspect of the invention, we provide a boundary layer flow control apparatus comprising a surface, over which fluid can flow in a boundary layer; and a plurality of blades projecting from the surface, the blades being configured such that in use they are capable of controlling the flow of fluid within the boundary layer.

In a preferred embodiment the blades are aligned with the expected direction of the fluid flow, and are in use capable of straightening the fluid flow in the boundary layer, thereby reducing surface friction or drag in comparison with the same surface without such flow control apparatus.

Alternatively, the blades are orientated at an angle across the expected direction of the fluid flow, and are capable in use of inducing turbulence or vortices in the fluid flow in the boundary layer, thereby increasing surface friction or drag in comparison with the same surface without flow control apparatus.

In a preferred configuration the blades may be mounted substantially vertically on the surface, configured as flat plate elements which are generally rectangular. Preferably the blades have a constant cross section across the length and/or the width of the blade. Furthermore, the blades may be mounted generally parallel and be of uniform height and/or width, and/or chord, and/or spacing, and/or orientation and/or dimensions and/or rigid in use. Alternatively the blade dimensions may vary across a surface.

Preferably, the blades project into the boundary layer by 100 to 200 wall units, for example between about 25% and about 50% of the boundary layer depth. The wall units are non-dimensional units based on the local inner flow conditions, h⁺=hu*/v, where h⁺ is the non-dimensional blade height, h is the actual height, u* is the friction velocity, and v is the kinematic viscosity. The blade may be 1 mm high, have a 1 mm chord and be spaced by 1 mm. Preferably the ratio of blade height to width to chord is selected from the following list:
1:1:1, 1:2:1, 1:3:1, 1:4:1, 1:5:1, 1:6:1
2:1:1, 2:2:1, 2:3:1, 2:4:1, 2:5:1, 2:6:1
3:1:1, 3:2:1, 3:3:1, 3:4:1. 3:5:1, 3:6:1
4:1:1, 4:2:1, 4:3:1, 4:4:1, 4:5:1, 4:6:1
5:1:1, 5:2:1, 5:3:1, 5:4:1, 5:5:1, 5:6:1
6:1:1, 6:2:1, 6:3:1, 6:4:1, 6:5:1, 6:6:1
1:1:2, 1:2:2, 1:3:2, 1:4:2, 1:5:2, 1:6:2
2:1:2, 2:2:2, 2:3:2, 2:4:2, 2:5:2, 2:6:2
3:1:2, 3:2:2, 3:3:2, 3:4:2, 3:5:2, 3:6:2
4:1:2, 4:2:2, 4:3:2, 4:4:2, 4:5:2, 4:6:2
5:1:2, 5:2:2, 5:3:2, 5:4:2, 5:5:2, 5:6:2
6:1:2, 6:2:2, 6:3:2, 6:4:2, 6:5:2, 6:6:2
1:1:3, 1:2:3, 1:3:3, 1:4:3, 1:5:3, 1:6:3
2:1:3, 2:2:3, 2:3:3, 2:4:3, 2:5:3, 2:6:3
3:1:3, 3:2:3, 3:3:3, 3:4:3, 3:5:3, 3:6:3
4:1:3, 4:2:3, 4:3:3, 4:4:3, 4:5:3, 4:6:3
5:1:3, 5:2:3, 5:3:3, 5:4:3, 5:5:3, 5:6:3
6:1:3, 6:2:3, 6:3:3, 6:4:3, 6:5:3, 6:6:3
1:1:4, 1:2:4, 1:3:4, 1:4:4, 1:5:4, 1:6:4
2:1:4, 2:2:4, 2:3:4, 2:4:4, 2:5:4, 2:6:4
3:1:4, 3:2:4, 3:3:4, 3:4:4, 3:5:4, 3:6:4
4:1:4, 4:2:4, 4:3:4, 4:4:4, 4:5:4, 4:6:4
5:1:4, 5:2:4, 5:3:4, 5:4:4, 5:5:4, 5:6:4
6:1:4, 6:2:4, 6:3:4, 6:4:4, 6:5:4, 6:6:4
1:1:5, 1:2:5, 1:3:5, 1:4:5, 1:5:5, 1:6:5
2:1:5, 2:2:5, 2:3:5, 2:4:5, 2:5:5, 2:6:5
3:1:5, 3:2:5, 3:3:5, 3:4:5, 3:5:5: 3:6:5
4:1:5, 4:2:5, 4:3:5, 4:4:5, 4:5:5, 4:6:5
5:1:5, 5:2:5, 5:3:5, 5:4:5, 5:5:5, 5:6:5
6:1:5, 6:2:5, 6:3:5, 6:4:5, 6:5:5, 6:6:5
1:1:6, 1:2:6, 1:3:6, 1:4:6, 1:5:6, 1:6:6
2:1:6, 2:2:6, 2:3:6, 2:4:6, 2:5:6, 2:6:6
3:1:6, 3:2:6, 3:3:6, 3:4:6, 3:5:6, 3:6:6
4:1:6, 4:2:6, 4:3:6, 4:4:6, 4:5:6, 4:6:6
5:1:6, 5:2:6, 5:3:6, 5:4:6, 5:5:6, 5:6:6
6:1:6, 6:2:6, 6:3:6, 6:4:6, 6:5:6, 6:6:6

Blade height, chord or spacing may be between 2 and 10 mm. Blade width may be about 0.1 mm, alternatively the blades may be 0.2 to 10 mm thick. Blade height may be 0.5 mm. Alternatively, blade height may be between 0.6 and 10 mm high.

Blades may have a chord of 0.5 mm. Alternatively, blades may have a chord of 0.6 to 10 mm. The blades may be spaced by 0.3 mm. Alternatively, blades may be spaced by 0.4 to 10 mm.

The blade height and/or chord and/or spacing may vary over the surface upon which they are mounted.

In a further embodiment the blade orientation can be adjusted relative to the direction of fluid flow, indeed it may be that the blade orientation can be adjusted to maintain a fixed orientation relative to the direction of fluid flow.

Preferably blades may be actively controlled, such that their location can be alternated between a positive (aligned with the fluid flow) and a negative (orientated across the fluid flow) angle of attack. Counter rotation of the blades on an aircraft can be used to energise the boundary layer and prevent separation occurring at certain points in the flight envelope, such as stall separation at high aircraft incidences. When separation control is not required the blades can be realigned to the flow to give skin friction reduction. To allow blade rotation some adjustment of streamwise spacing may be required.

Actively adjustable blades also provide directional control allowing for local or selective steering of fluid flow. For example, on an aircraft, by reducing skin friction on one wing and increasing skin friction on the other local yawing moments can be produced. Similarly, the manipulation of air flow around the stabilisers can produce pitching moments.

Whilst in the preferred arrangements discussed above the blades are configured as thin rectangular elements, mounted extending directly away from a surface, alternative configurations comprising various blade shapes and angles of projection are envisaged.

In a further embodiment of the invention, an array of blades is envisaged, with at least one row of parallel blades. However, as the straightening effect of the blades on the fluid flow boundary layer is only transient, turbulence may begin to re-appear in the flow after the fluid has flowed a significant distance past a row of blades. Thus, repeated rows of blades may be employed, spaced to prevent significant turbulence re-emerging in the fluid flow. In a preferred blade array, this spacing is some 50 to 100 times blade height. Alternatively, the rows of blades may be spaced by 80 mm to 200 mm in the streamwise direction.

Preferably, the array of blades comprises at least two rows of blades. The first row comprising a plurality of parallel blades aligned with the direction of fluid flow, and the second row also comprising a plurality of parallel blades aligned with the direction of fluid flow. Preferably there are no blades in the gap between the two rows of blades. Preferably, blades in the first row share a substantially common longitudinal axis with blades in the second row.

This is in contrast to the riblets described in U.S. Pat. No. 4,706,910, which must be applied over the entire surface where a reduction in drag or surface friction is sought. Furthermore, the configuration of the riblets as small ‘v’ grooves (of 0.05-0.5 mm) results in problems of debris or dirt becoming lodged therein, resulting in high maintenance demands.

According to a further aspect, the invention provides a surface upon which is mounted a boundary layer flow control apparatus according to the invention.

Preferably the surface is on a vehicle, such as a plane, or on a pipe.

In a yet further embodiment of the invention, flow manipulator blade elements are provided mounted on a strip or patch, which can be incorporated on a surface during article or surface manufacture, or can be applied to an existing surface, for example, blades may be retrofitted to a surface on a vehicle or in a pipe. In particular, the blades may be applied to the surface of an aircraft. Alternatively, the blades may be applied to the fluid-surface interface of a pipe or any fluid-carrying conduit.

On an aircraft, with a body, wing and tail sections, the boundary layer control apparatus may be mounted upon the body, wing, and/or tail sections.

In a pipe, the boundary layer flow control apparatus may be mounted on the internal surface. Preferably the pipe has a central axis about which the flow manipulator blades are radially located, extending inwards towards the central axis. The blades may be located as one discrete band, or multiple discrete bands, on the internal surface of the pipe.

According to a still further aspect, the invention provides an aircraft with a boundary layer flow control apparatus according to the invention mounted upon the surface wherein the blades are moveable between a first configuration, in which the blades are orientated to straighten fluid flow in the boundary layer, and a second configuration, in which the blades are orientated to induce turbulence in the boundary layer.

According to another aspect, the invention provides a method of reducing the surface drag of an aircraft having an outer surface skin comprising affixing a large number, preferably at least five hundred, of flow manipulator control blades to the surface skin, the blades being aligned with the expected direction of fluid flow past the aircraft skin.

Alternatively, at least one thousand blades may be at least a fixed to be surface skin, or at least ten thousand blades may be affixed to the surface skin.

According to another aspect, the invention provides a method of reducing the surface drag in a pipe or conduit having an inner surface comprising affixing flow manipulator control blades to the inner surface, the blades being aligned with the expected direction of fluid flow past the surface.

The blades of the subject invention are self-supporting and therefore are to a large degree free of the constraints of the LEBU devices that require suspension.

When the blades are configured to reduce surface friction or drag, and are flow aligned, any device drag will be minimal, the device thickness being sufficiently low to give low form drag.

A reduction in surface friction or drag is observed when using flow aligned vertical blade elements due to a number of effects which include disruption of lifted longitudinal vortices associated with the near wall structure. Also near field disruption of longitudinal vortices is observed. Further from the wall/surface the blade elements interact with the head and neck of hairpin or horseshoe vortices, cancelling and unwinding them to reduce surface friction or drag. The blade elements also have a plate effect and a wake effect which inhibits spanwise turbulent motions in the boundary layer, hence reducing wall normal and longitudinal vorticity components.

It will be appreciated that the optional features discussed in relation to any aspect of the invention may apply to all aspects of the invention.

Embodiments of the invention will now be described in more detail by way of example with reference to the accompanying drawings, of which:

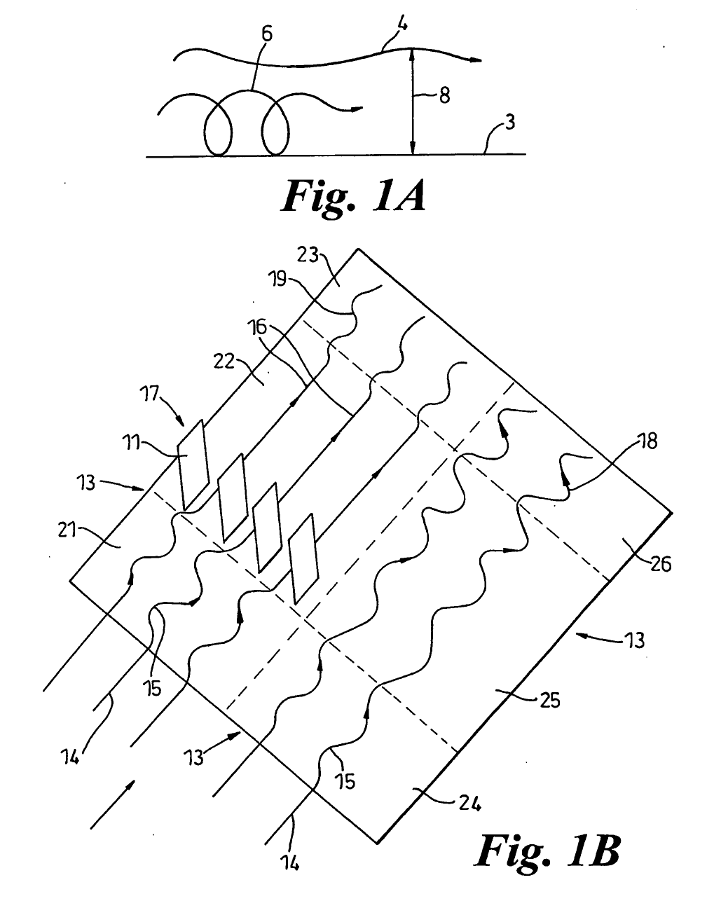

FIG. 1A shows schematically the location of a boundary layer;

FIG. 1B shows a schematic perspective view of a surface upon part of which is mounted a row of flow manipulator blades;

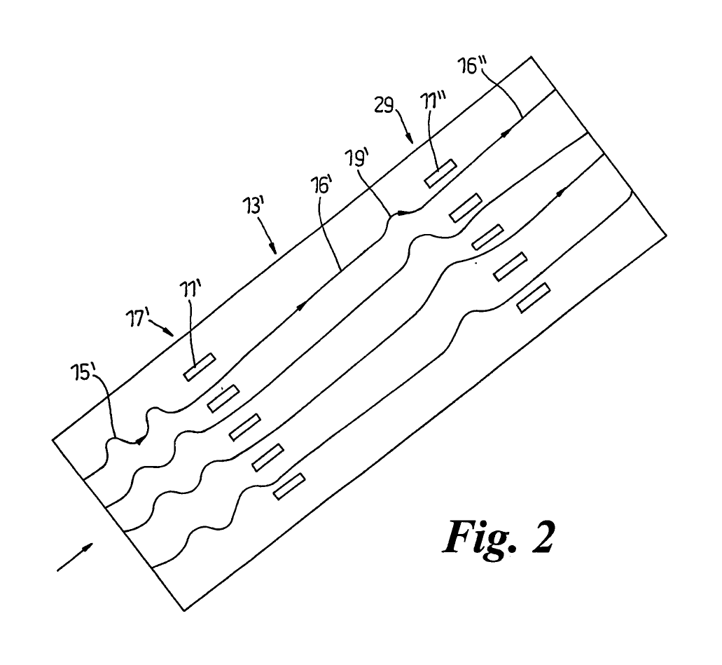

FIG. 2 shows a schematic view from above of an array of flow manipulator blades, similar to those of FIG. 1;

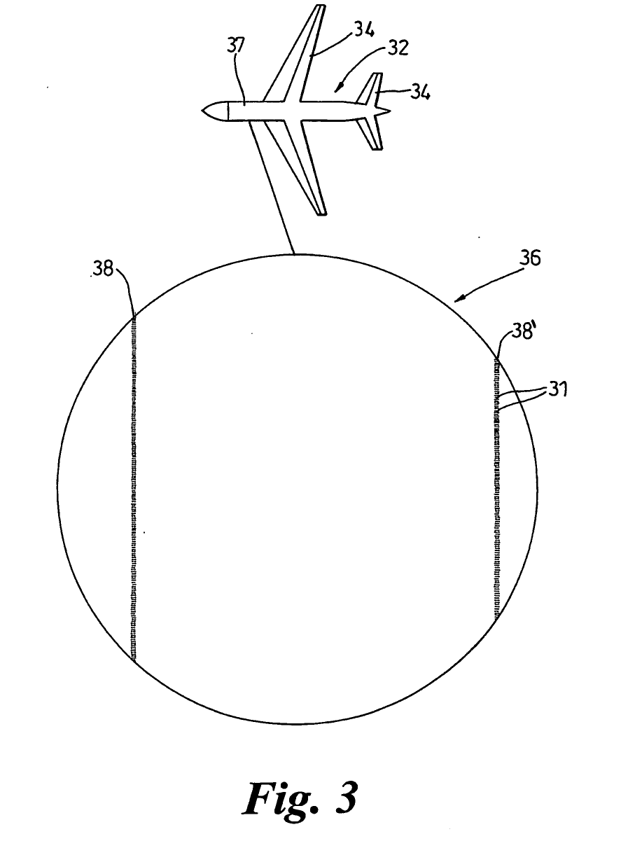

FIG. 3 is a schematic perspective view of flow manipulator blades applied to an aircraft;

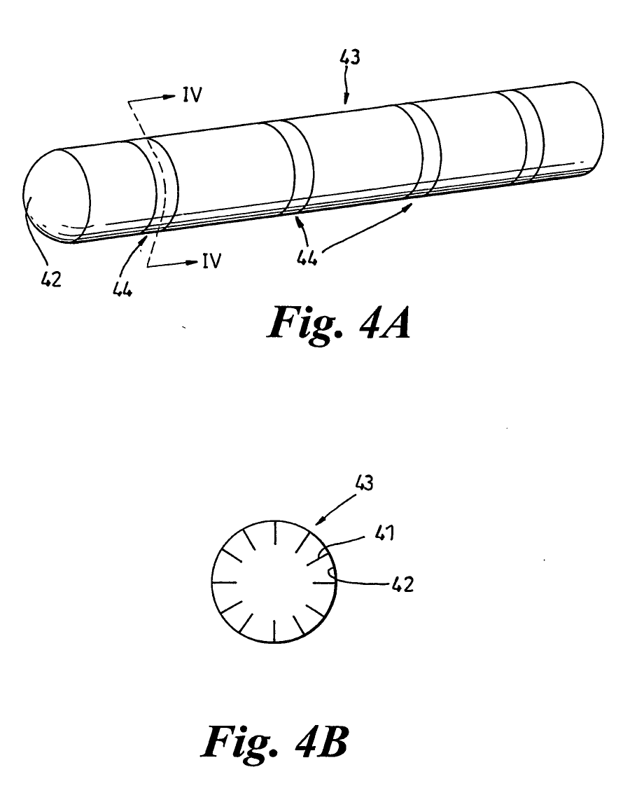

FIGS. 4A and 4B show flow manipulator blades applied to the internal surface of a pipe;

FIG. 5 is a schematic perspective view of flow manipulator blades as used in fluid flow experiments;

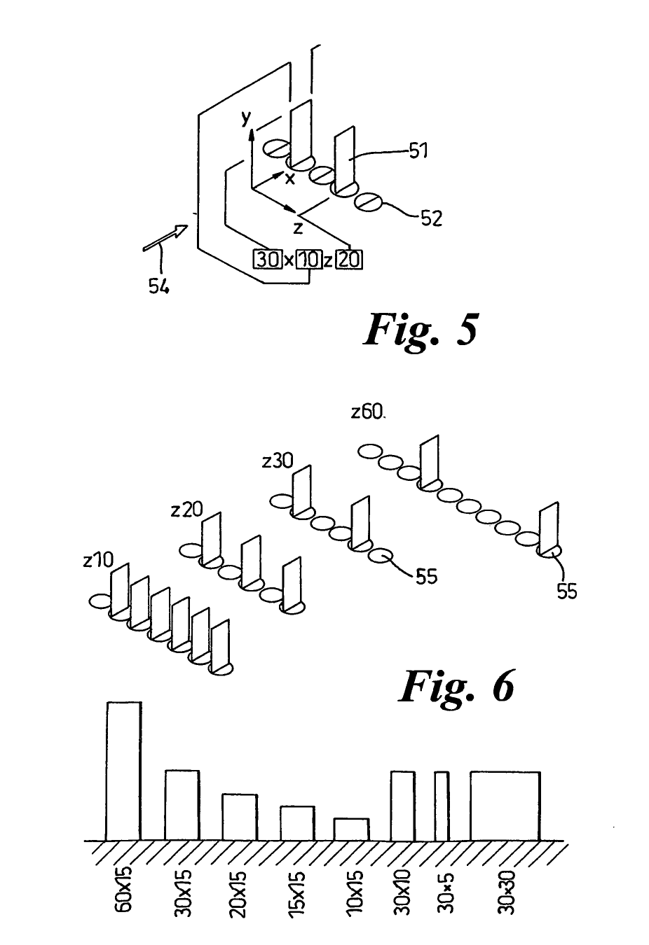

FIG. 6 depicts alternative blade spacing, width and height to those depicted in FIG. 5;

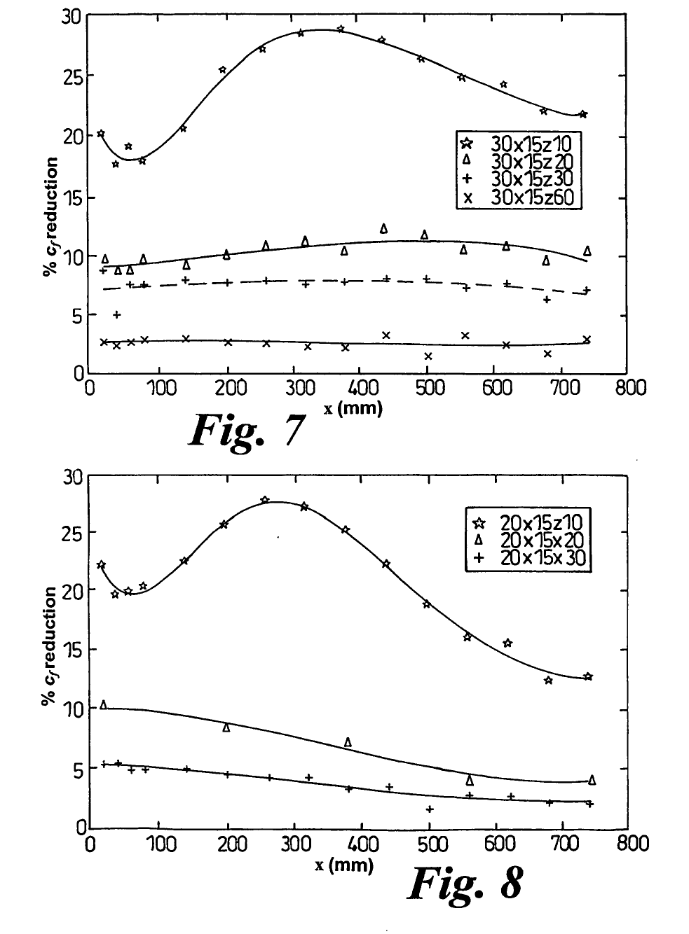

FIGS. 7 and 8 show graphically the effect of varying flow manipulator blade spacing on surface friction levels for various blade heights;

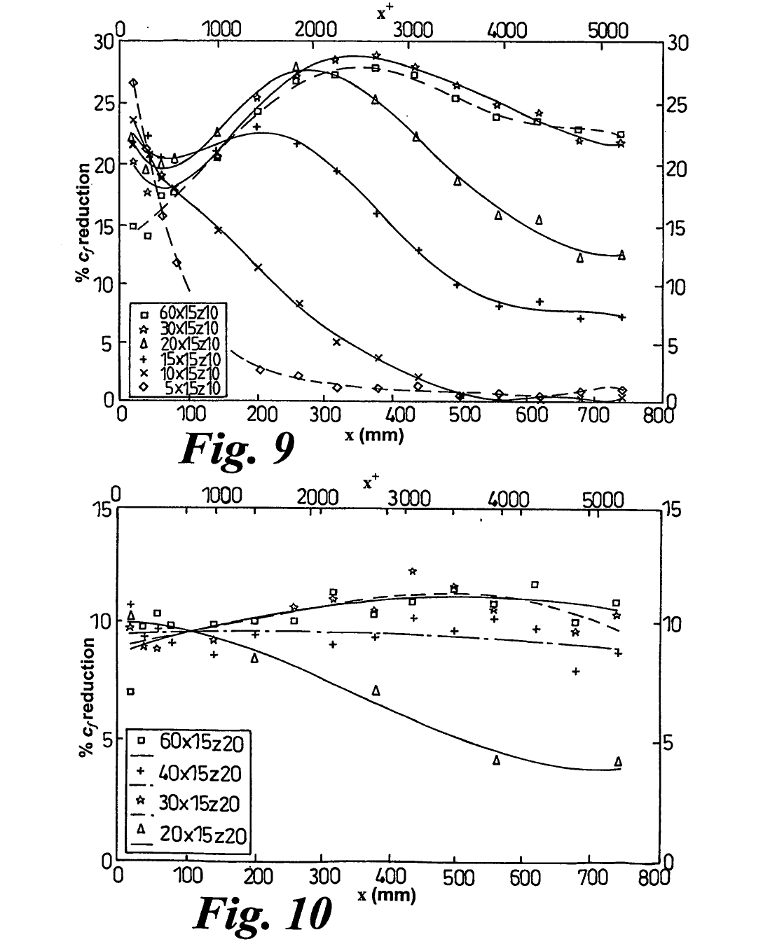

FIGS. 9 and 10 shows graphically the effect of flow manipulator blade height on surface friction levels for various flow manipulator blade spacings;

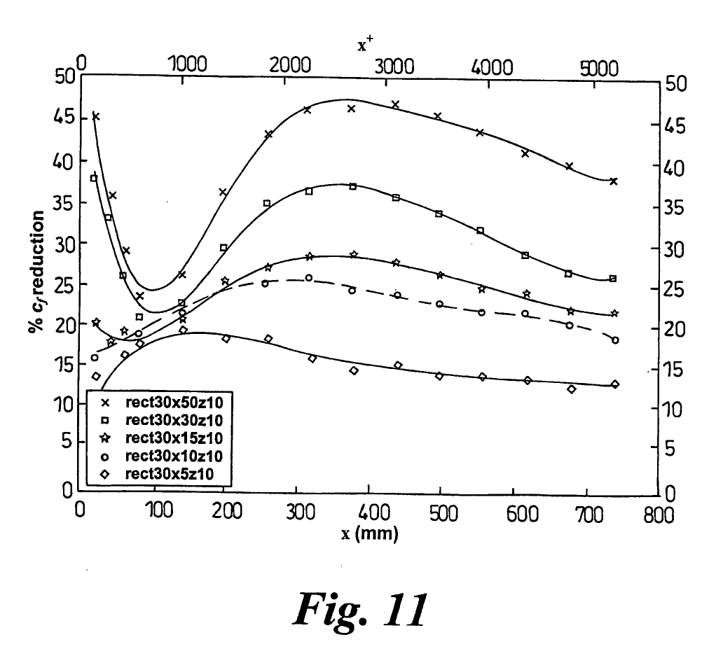

FIG. 11 shows graphically the effect of flow manipulator blade chord on the surface friction levels;

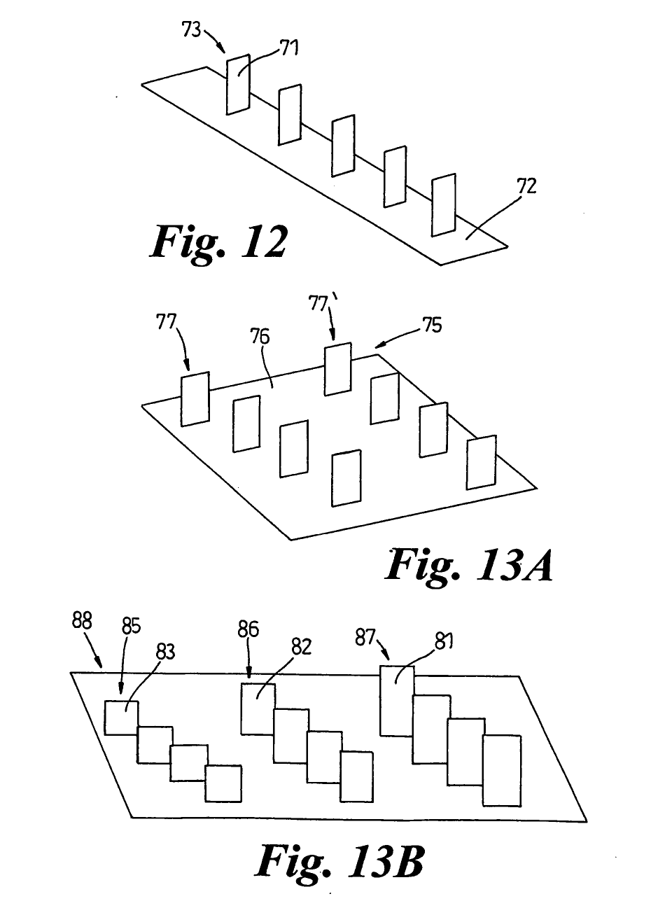

FIG. 12 shows a perspective schematic view of flow manipulator blades mounted in a row upon a strip;

FIGS. 13A and 13B show perspective schematic views of flow manipulator blades mounted in rows upon a patch;

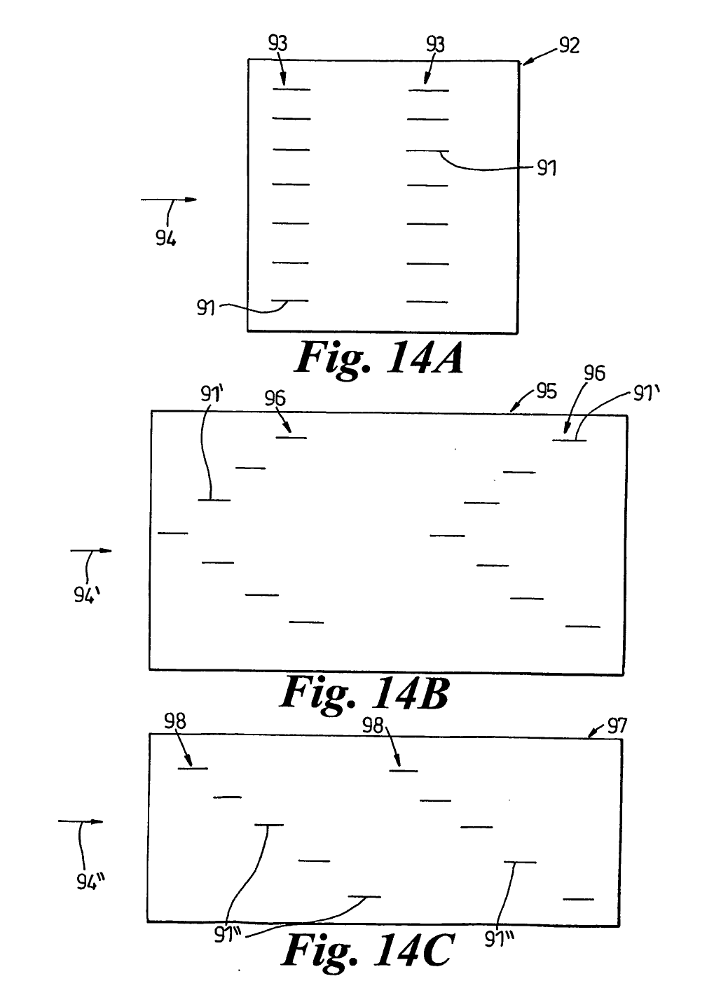

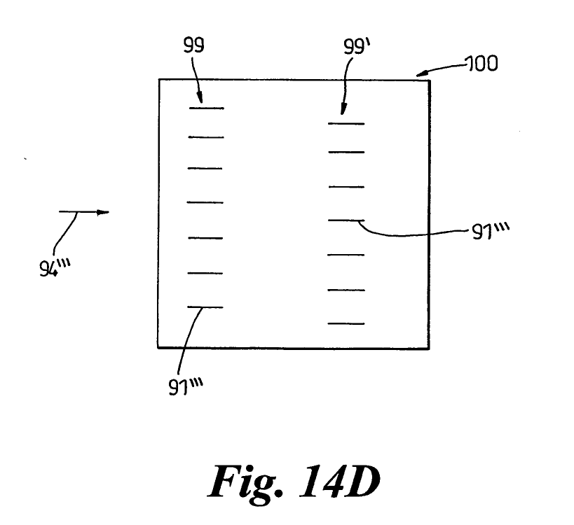

FIGS. 14A to 14D show schematic views from above of alternative array configurations of flow manipulator blades;

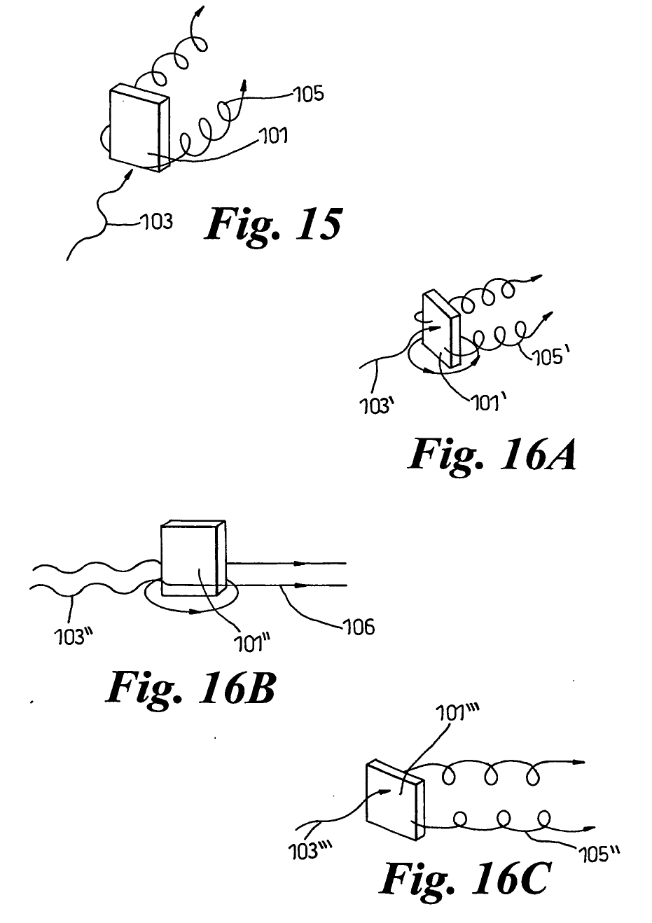

FIG. 15 shows a schematic view of a flow manipulator blade positioned perpendicular to the direction of fluid flow;

FIGS. 16A to 16C show schematic views of a movable blade;

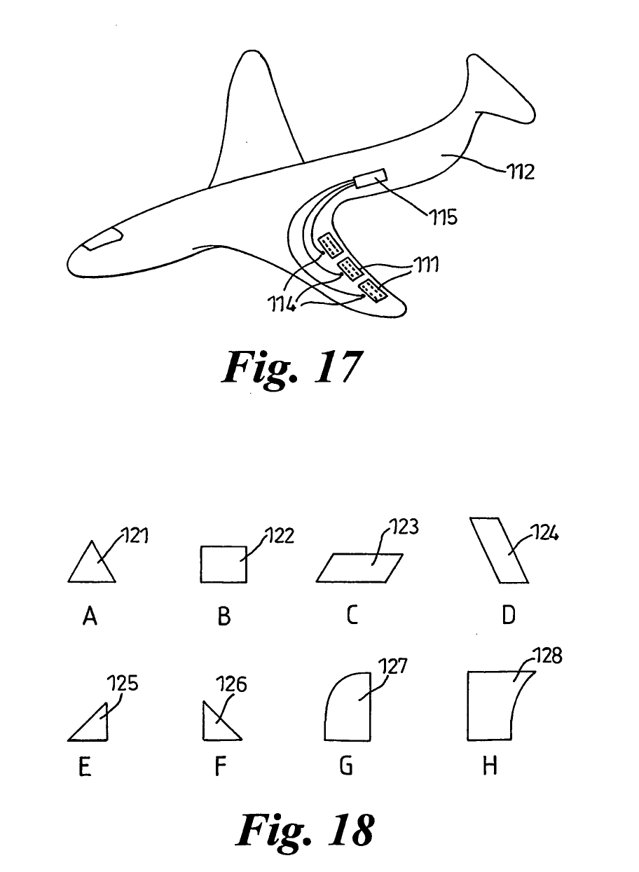

FIG. 17 shows a schematic representation of an aircraft fitted with ‘intelligent’ flow manipulator blades;

FIGS. 18A to 18H show alternative flow manipulator blade geometries;

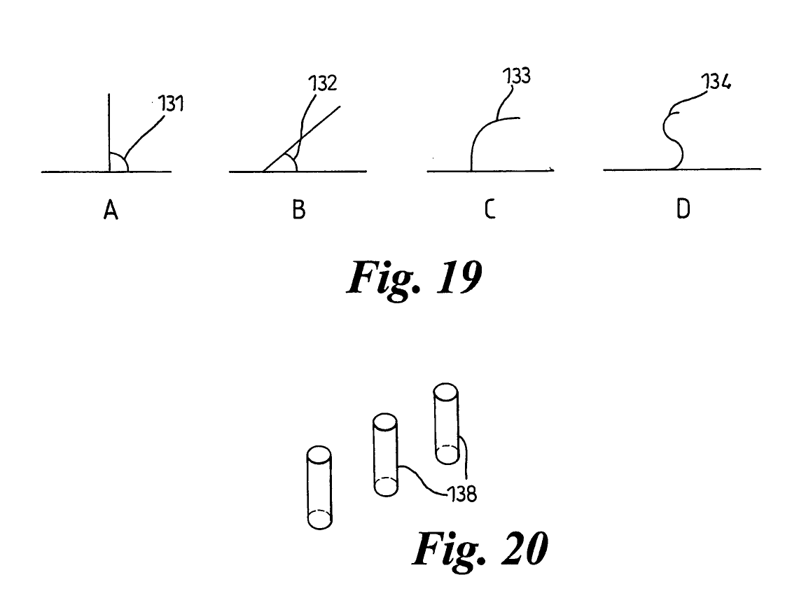

FIGS. 19A to 19D show variant flow manipulator blade mounting angles; and

FIG. 20 depicts a series of pins for use in manipulating boundary layer fluid flow.

FIG. 1A shows schematically the flow 4,6, of fluid flow over a surface 3 to illustrate the location of the boundary layer. Essentially, there is a main stream flow of fluid 4 over a surface 3. Upon contact with the surface the flow is disrupted at the fluid-surface interface. This layer of disrupted air flow 6, between the surface 3 and the mainstream flow 4, is known as the boundary layer 8. The depth of the boundary layer varies depending upon relative velocity and direction of the air movement, and the viscosity of the fluid

FIG. 1B depicts a perspective view of an array 17 of flow manipulator blades 11 mounted upon a surface 13. Disruption 15 of the general fluid flow 14 at the fluid 14—surface 13 interface is illustrated.

The surface 13 is depicted divided into six zones, three located uppermost on the surface 21, 22 and 23, and three lowermost 24, 25 and 26. Zones 21, 22 and 23 illustrate the effect of flow manipulator blades 11 on fluid flow 14 in the boundary layer. By way of contrast, zones 24, 25 and 26 illustrate fluid flow over a clean flat planar surface without flow manipulator blades.

Considering firstly the lowermost zones 24, 25 and 26 of the surface 13—which represent the clean surface, as fluid flow 14 passes over the surface in zone 24, turbulence 15 begins to appear in the boundary layer. As fluid flow progresses through zones 25 and 26 the turbulence 18 increases. This increased turbulence 18 results in increased surface friction or drag.

In contrast, the uppermost zones 21, 22 and 23 illustrate the effect of flow manipulator blades 11 on fluid flow in the boundary layer. As shown in the lower zone 24, when fluid flow passes over the surface 13 in zone 21 the fluid flow is disrupted and turbulence 15 begins to occur in the boundary layer. As the turbulent fluid flow 15 enters zone 22 and passes through the vertically mounted parallel, thin, rectangular blade elements 11, mounted in an array 17 upon the surface 13, the flow is straightened and becomes more laminar 16 in nature.

In this embodiment the blades 11 are configured as an array 17 of parallel blades 11 positioned in a row, each blade 11 being aligned with the direction of fluid flow 14—that is, at a zero angle of attack to the fluid flow. The blades 11 are equally spaced, positioned at right angles to the surface 13 and all have constant height, chord and width.

However, the straightening effect on the flow is only transient, and turbulence will begin to develop again some distance downstream of the blades 11, as illustrated in zone 23 where turbulence 19 is beginning to reappear in the generally laminar flow 16.

FIG. 2 further illustrates the transience of the straightening effect of the flow manipulator blades 11′ on the fluid flow 14′. A first array or row 17′ of flow manipulator blades 11′ is depicted (which is similar to the array 17 of FIG. 1), together with a second array or row 29 of blades 11″, parallel to the first array 17′. This second array 29 is located downstream of the first array 17′ and is positioned where previously straightened fluid flow 16′ begins to become disrupted and turbulent 19′ again. The second array 29 serves to re-straighten the fluid flow, maintaining a more laminar flow 16″ over a greater length of surface 13′. For example, when the blades extend by 100 to 200 wall units into the boundary layer, it is anticipated that a second row of blades will be positioned about 50-100 times the blade height downstream. The longitudinal axis of the first blade 11′ is in substantially the same plane as the longitudinal axis of second blade 11″.

By straightening the flow of fluid in the boundary layer, turbulence is reduced, and friction or surface drag at the fluid-surface interface is decreased.

The reduction of boundary layer fluid flow turbulence, and hence drag or surface friction, has of long been a concern in aircraft design. It is envisaged that the flow manipulator blade elements subject of this invention will be suitable for mounting upon the outer surface of an aircraft to reduce friction.

FIG. 3 illustrates a schematic aircraft 32 highlighting possible regions 34 where turbulence and friction may be a problem, and where flow manipulator blades 31, aligned with the expected direction of fluid flow, would serve to straighten fluid flow and reduce friction. For economic reasons it is unlikely that flow manipulator blades would be mounted over an entire aircraft surface, it is unlikely that blades will be mounted on areas which experience predominantly laminar flow, such as around the nose, the forward fuselage and the front sections of the wings, tail and stabilisers. More likely fluid flow manipulator blades 31 will be applied only to those regions 34 where drag or surface friction is a problem. Indeed, it is likely that the blades will be spaced as discussed in FIG. 2 to overcome the transience of the straightening effect thereby producing a striped or ‘lemur tail’ effect in regions 34. Exploded view 36 illustrates an area of the aircraft surface 37 and shows two spaced rows 38,38′ of blades 31. In addition, blades may also be located upstream of an air intake in order to improve the efficiency of the intake.

It anticipated that some 10,000s of flow manipulator blades will be applied to a aircraft, with rows of blades typically spaced by 80 to 200 mm and located predominantly on the rear of the wings, nose, tail, and stabiliser and along the length of the fuselage with the exception of the nose and most forward regions. The large number of blades to be used means the loss or damage to any one blade would likely have no significant impact on the overall effect of the blade arrays.

Typically, on an aircraft, blades will be configured to be flow aligned when the aircraft is cruising. For most aircraft the flow vector corresponding to direction of fluid flow over various parts of the aircraft is known, as indeed are the appropriate laminar/turbulent transition points.

FIGS. 4A and 4B illustrate an alternative practical use for the flow manipulator blades 41 described, and that is mounted on the interior surface 42 of a pipe 43. Indeed they could be located on the fluid-surface interface of any fluid carrying conduit, such as an open channel.

In more detail, FIG. 4A illustrates a pipe 43 upon which are mounted, on the inner surface 42, flow manipulator blade elements 41 (not visible in FIG. 4A). The blades are orientated to be aligned with the fluid flow in the pipe, and serve to straighten fluid flow in the boundary layer at the fluid-surface interface. The blades are located as series of bands 44 at spaced intervals along the length of the pipe 43, downstream bands being employed to re-straighten fluid flow before significant turbulence re-appears. It is envisaged that a pipe carrying water of diameter 1.2 m with a flow rate of 1.5 m³/s will have blades of dimension 3.6 mm spaced at 1.8 mm intervals.

FIG. 4B depicts a cross section along IV-IV of FIG. 4A. Flow manipulator blade elements 41 project from the inner surface 42 of the pipe 43 and into the fluid flow—more specifically the blades are located radially about the central axis of the pipe, extending inwards towards the central axis. The blades 41 are orientated to be aligned with direction of fluid flow.

These examples of practical uses of the flow manipulator blades are by no means exhaustive, the blades could be employed to reduce or increase friction wherever there is a fluid-surface interface.

FIGS. 5 through 11 depict the results of wind tunnel experiments undertaken to study the efficiency in modifying surface friction levels of various dimensions and spacings of a row of flat plate parallel rectangular blade elements, flow aligned (zero angle of attack) and mounted vertically to a surface.

The air speed used in the wind tunnel for these experiments was 2.5 ms⁻¹, which is significantly lower than the airspeed passing over an aircraft during flight.

The reduced air speed in the wind tunnel experiments requires larger blades to be used than would be necessary at higher fluid velocities. It is anticipated that when applied to an aircraft the blades will have a chord, height and spacing of only several millimetres. Typically, on a large passenger aircraft blades will be arranged from the start of the boundary layer in spanwise arrays, with a spanwise spacing of 70 to 150 wall units and a height of 100 to 200 wall units.

Thus, for an aircraft cruising at a velocity of 269 ms⁻¹, with an air viscosity of 3.5303e-5 m²s⁻¹ and a fuselage length from transition (where turbulent air flow begins to appear) to trailing edge of approximately 50 m, surface friction or drag could be reduced by using blades ranging in height from approximately 0.7 mm at transition to 1 mm by the end of the fuselage, with a characteristic spacing ranging from 0.3 to 0.4 mm. The blades being repeated in the streamwise direction approximately every 80 to 200 mm depending on precise location and optimisation. This in comparison to the much smaller ‘riblet’ devices which are typically approximately 50 microns in height and spacing, and the much larger LEBU devices which range from a location 20 mm from the wall in the forward position and 0.4 m from the wall at the tail end of the fuselage.

The data from the wind tunnel experiment can be scaled to apply at any given air speed using the scaling law/design rule h⁺=hu*/v.

All blades used in the wind tunnel experiments are made from −0.3 mm (0.012 inch) plastic or steel shim. Thickness is not considered to play a major part in skin friction reductions, but may play a large role when considering overall device drag—the thinner the device the less the device drag.

FIG. 5 is useful in explaining the dimension nomenclature used in subsequent studies to describe the flow manipulator blade geometry and spacing. The studies consider the parameters of:
blade height h—height of the blade in the surface(wall)-normal y direction; and
blade chord c—length of the blade in streamwise x direction;
blade packing—spacing between blades in the spanwise z direction.

Thus, a blade described as 30x10z20 would have:
blade height h of 30=30 mm;
blade chord c of x10=10 mm;
blade packing of x20=20 mm.

In the wind tunnel experiments the blades 51 are mounted in slotted brass pegs 52 flush with the test surface (not shown in this figure).

In the wind tunnel experiments discussed below, the flow manipulator blades 51 are aligned with the direction of fluid flow 54.

FIG. 6 illustrates examples of alternative flow manipulator blade spacing, height and chord dimensions, as used in subsequent experiments. In the wind tunnel experiments blade elements are mounted on 10 mm pegs 55, and can therefore be spaced at a minimum of 10 mm intervals. 10 mm (z10 ), 20 mm (z20), 30 mm (z30) and 60 mm (z60) spacing is illustrated. Various chord and height dimension combinations are depicted, for example, 60×15 represents a blade with a height of 60 mm and a chord of 15 mm.

FIGS. 7 through 11 illustrate the results of parametric studies undertaken in the wind tunnel, according to the conditions described previously, to study the effect of blade geometry on skin friction levels. The studies examine effects up to 740 mm downstream from the blade trailing edge. Downstream locations are denoted on the graph as x(mm).

Spanwise Packing of Blades

FIGS. 7 and 8 consider the effect of spanwise packing, that is, relative spacing, of the blades on skin friction levels observed at the fluid-surface interface.

FIG. 7 illustrates graphically the effect of spanwise flow manipulator blade packing on averaged c_{f} reductions for blade height h=30 mm and chord=15 mm. Blade packing is varied to include 10 mm, 20 mm, 30 mm and 60 mm spacing.

Skin friction is recorded using the c_{f} measurement technique which gives comparative skin friction results to <±1.5 % error, and is described in Hutchins and Choi, AAIA (American Institute of Aeronautics and Astronautics) Paper-2001-2914. C_{f} is proportional to the velocity gradient near the body surface, and is determined by taking an accurate measurement of velocity near the wall in order to determine C_{f} values. Essentially, c_{f} can be regarded as a measure of skin friction, and the terms are used interchangeably.

The percentage c_{f} reduction is determined at intervals downstream from the trailing end of the device up to 740 mm. The width of the study area is 60 mm.

The results show that the skin friction (percentage c_{f}) reduction increases for increased spanwise packing (that is the blades are closer together). This perhaps is not altogether surprising since as spanwise packing increases more material is being put into the path of the flow—more frontal area, more surface area and more wake is being put into the boundary layer.

For example, consider z60 (60 mm blade spacing), which in this case, over a 60 mm by 740 mm area, is a single 30×15 (30 mm high and 15 mm chord) blade element, and a reduction of approximately 2.6% in the c_{f} is observed.

In contrast, for the z10 (10 mm blade spacing) spanwise packing, with six 30×15 blade elements, in the same 60 mm by 740 mm area, a 24% reduction in the c_{f} is observed—somewhat more than six times the z60 reduction. Thus, spanwise packing cannot be considered as a simple additive process, but that closer packed arrays are more effective at reducing surface friction.

FIG. 8 illustrates graphically for a smaller range of variables the effect on c_{f} (skin friction) values of varying the spanwise packing between 10 mm, 20 mm and 30 mm, for flow manipulator blades with a fixed chord c of 15 mm and a height h of 20 mm (rather than the 30 mm in FIG. 7). Again, a similar trend in skin friction reductions is noted, the closer the blades the greater the percentage c_{f} reduction.

Blade Height

FIG. 9 illustrates the effect of blade height of surface friction levels, in general an increase in blade height results in a reduction in surface friction.

In more detail, FIG. 9 illustrates graphically the effect of varying the blade height, between 5 and 60 mm on the percentage c_{f} reduction, data was taken at various intervals from the trailing edge of the device to 740 mm downstream. The chord c is fixed at 15 mm and the spanwise packing is fixed at 10 mm spacing. The percentage c_{f} reduction observed increases with blade height, over at least the first 740 mm, to a limit of (blade height) h=30 mm, after which additional c_{f} reductions are minimal for further blade height increase.

FIG. 10 illustrates graphically a similar effect on skin friction levels to that of FIG. 9 when blade height is varied for spanwise packing of z20 (20 mm blade spacing). Consistent with FIGS. 7 and 8 the overall magnitude of the peak c_{f} reductions is considerably lower than FIG. 9 due to the increased spanwise spacing.

Again, an increase in percentage c_{f} reduction is seen with increasing blade height, up to a limit of (blade height) h=30 mm, at least in the region up to 740 mm downstream of the blade array. In fact, blade heights of 30, 40 & 60 mm all look quite similar, especially if a ±1% accuracy on c_{f} measurements is included. Further downstream (beyond 740 mm) persistence of the effect is not analysed.

Blade Chord

FIG. 11 illustrates graphically the effect of flow manipulator blade chord c on spanwise averaged c_{f} reductions for spanwise packaging z10 (10 mm blade spacing) and height h=30 mm. The blade chord is varied between 5 and 50 mm. c_{f} levels are recorded at intervals up to 740 mm downstream of the blade array trailing edge.

As the blade chord is increased from 5 to 50 mm there is a corresponding increase in skin friction (c_{f}) reduction.

Application of Flow Manipulator Blades

Flow manipulator blades may be incorporated onto a surface during manufacture or retrofitted to an article, that is, fitted to a surface post-production. This would allow the blades to be fitted to an aircraft already in service, or to be added to pipes after manufacture but before they are laid.

Blades may be applied individually, or as a group. FIG. 12 illustrates an array of parallel rectangular blades 71, mounted horizontally on a strip or tape 72 ready for attachment as a row 73 upon a surface, such as the wing of an aircraft.

Alternatively, blades may be mounted as an array 75 on a patch 76, as illustrated in FIG. 13A, ready for attachment to a surface. Spacing of the parallel rows 77, 77′ is optimised for use to prevent the re-appearance of turbulence in fluid flow that has already been straightened by the forward row of blades 77. FIG. 13B depicts an alternative to that of FIG. 13B in which the blade height increases in each row 85, 86, 87 across the surface 88, that is blade 81 is higher than blade 82 which is higher than blade 83. Spacing of the rows is optimised to reduce the re-appearance of turbulent fluid flow. Blades 81, 82 and 83 share a common longitudinal axis.

FIG. 14A to 14D illustrate, in plan, various schematic blade arrays. FIG. 14A illustrates an array 92 of flow manipulator blades 91 configured as two parallel rows 93 of individual flow manipulator blades 91. The individual blades 91 are orientated in line with the direction of fluid flow 94.

By way of contrast, FIG. 14B depicts an alternative array 95 in which individual flow manipulator blades 91′ are arranged in two parallel chevrons 96. Individual blades 91′ are orientated in line with the direction of fluid flow 94′.

A yet further array 97 is depicted in FIG. 14C. In this case individual blade elements are arranged in two parallel diagonal rows 98. Individual blades 91″ are orientated in line with the direction of fluid flow 94″.

A still further array 100 is depicted in FIG. 14D configured as two parallel rows 99, 99′ of individual flow manipulator blades 91′″. The individual blades 91′″ are orientated in line with the direction of fluid flow 94′″. In contrast to FIG. 14A the first row 99 and second row 99′ of blades are offset somewhat.

In each case, two rows or two chevrons are illustrated, the first row serving to straighten fluid flow upon passage over the blades, and the second row or chevron is intended to re-straightens flow in which turbulence has begun to reappear. Whilst the illustrations depict only two rows, in practice any number of rows could be employed.

If blades are to be fitted to an aircraft, or indeed any riveted surface, if may be convenient to manufacture the rivets to include a flow manipulator blade, possible integrated with the rivets (not illustrated).

As well as reducing drag or surface friction by the straightening of fluid flow by using flow aligned blades to produce more laminar flow in the boundary layer. It may be desirable in some circumstances to disrupt the fluid flow in the boundary layer and thereby increase turbulence, and thus increase drag or surface friction.

By adjusting the angle of attack of the blade 101 to cross the fluid flow 103, as depicted in FIG. 15, the blade can serve to induce turbulence or vortices 105 in the fluid flow, thereby increasing drag or surface friction. This may be desirable say to increase the lift of an aircraft during take-off and landing.

In some circumstances it may be desirable to alter the use to which the blades are put, for example, skin friction could be reduced on one wing of an aircraft and increased on the other to produce yawing moments, or increased on the stabilisers to produce pitching moments.

Furthermore, the use of flow manipulator blade elements that can be moved to a desired angle of attack is envisaged. FIGS. 16A, 16B and 28C illustrate a movable (in this case rotatable) blade element. In FIG. 16A the blade 101′ is configured to have an angle of attack across, perpendicular to, the fluid flow 103′ and thereby induce turbulence 105′ in the fluid flow. By way of contrast, in FIG. 16B the blade 101″ has been rotated such that is now aligned, parallel, with the fluid flow 103″, the blade 101″ serves to straighten the fluid flow and the fluid flow downstream of the blade 101″ is more laminar 106 in nature. FIG. 16C shows a further variant in which the blade 101′″ is configured to have an alternative angle of attack across the fluid flow 103′″, again turbulence 105″ is induced.

Blade rotation could be manually controlled or computer controlled in response to a sensor system.

For any given surface the fluid flow in the boundary layer around that surface will vary depending on a number of factors, including the flow speed, the surface angle, the temperature, proximity to the surface edge, the nature of the fluid etc′.

For optimal efficiency in reducing surface friction or drag, an array of flow manipulator blades can be located on a surface to align with the predicted flow of fluid over the surface. For example, if blades are to be applied to a vehicle, the alignment will be optimised for a particular speed while travelling through a particular medium—say, for an aircraft travelling at 9144 metres (30,000 feet) at a speed of 650 kilometres per hour the typical properties of air encountered, including air viscosity, temperature, path of flow over the surface, at that height are known, thus the blades can be aligned accordingly to reduce surface friction by reducing turbulence in the boundary layer.

The resulting configuration is unlikely to be a row of parallel blades the length of the surface, but this could be a satisfactory approximation.

The angle of attack of the aligned blades with respect to the fluid flow will depend upon whether a reduction or an increase in drag or surface friction is sought.

In a more sophisticated variant, an array of blades may be configured to align themselves to the local fluid flow. A series of sensors may be located, for example, to the fore of the blades which are capable of determining the direction of fluid flow. In response to this information, which may be forwarded to a central processing unit for analysis, the blades can be continually tuned to the local fluid flow.

FIG. 17 depicts the use of ‘intelligent’ blade arrays 111 on an aircraft 112. Sensors 114 located on the body of the aircraft collect information regarding the direction of local airflow, which is relayed to a central processing unit 115 for analysis. In response to the local information received, the alignment of the blades can be automatically adjusted. When the aircraft is cruising it is intended that all blades will be flow aligned, to straighten air flow in the boundary layer and reduce surface friction. However, on take-off or landing it may be desirable to increase friction or surface drag on some areas of the aircraft, say to increase lift or to slow down, in these circumstances the appropriate blades can be rotated to be at an angle to the local flow to induce turbulence in the boundary layer.

As well as rectangular blade elements, other geometries could be employed as flow manipulator blades, examples are illustrated in FIGS. 18A through 18H, which depict various blade geometries, such as triangular 121, 125, 126 square 122, parallelogram elongated in the horizontal 123 or vertical 124, rectangular with a numbered leading edge 127, and rectangular with a sharpened trailing edge 128. This list is not exhaustive. Alternatively, the blades may be configured as aerofoil sections (not illustrated).

The blade elements discussed previously are all mounted vertically 131, at 90° to the surface, as illustrated in FIG. 19A. The blades could however be mounted at a more inclined angle 132 of less the 901, an example of such is depicted in FIG. 19B. Alternatively, blades could be bent or curved 133 as in FIG. 19C or sinusoidal 134 as in FIG. 19D.

FIG. 20 depicts a series of pins 138 which could be used, either singularly or in series, as an alternative to the blades discussed above. A row of pins can constitute a ‘blade’.

It is further envisaged that the device of the subject invention could be used in combination with other skin friction modifying techniques, including vortex generators, LEBU devices, riblets, compliant coatings, polymers/surfactants and/or micro-bubbles.

1-22. (canceled)

23. A method of controlling fluid flow in a boundary layer at a fluid-surface interface comprising: providing a plurality of blades which project from a fluid contacting surface into a boundary layer such that in use said blades are orientated to control fluid flow in said boundary layer.

24. A method according to claim 23, wherein said blades are orientated to straighten said fluid flow.

25. A method according to claim 23 wherein said blades are orientated generally aligned with the direction of fluid flow to straighten said fluid flow.

26. A method according to claim 23 wherein said blades are orientated to reduce the drag or surface friction at said fluid contacting surface.

27. A method according to claim 23 wherein said blades are orientated to induce turbulence or vortexes in said fluid flow.

28. A method according to claim 23 wherein said blades are orientated at an angle across the direction of said fluid flow to induce turbulence or vortexes in said fluid flow.

29. A method according to claim 23 in which said fluid contacting surface is that of a vehicle or fluid carrying conduit.

30. A boundary layer flow control apparatus comprising: a surface, over which fluid can flow in a boundary layer, and a plurality of blades projecting from the surface, said blades being configured such that in use they are capable of controlling said flow of fluid within said boundary layer.

31. A boundary layer flow control apparatus according to claim 30 in which, said blades are aligned with the expected direction of said fluid flow, and in use are capable of straightening said fluid flow in said boundary layer, thereby reducing surface friction or drag in comparison with the same surface without flow control apparatus.

32. A boundary layer flow control apparatus according to claim 30 in which said blades are orientated at an angle across the expected direction of said fluid flow, and are capable of inducing turbulence or vortexes in said fluid flow in said boundary layer in use, thereby increasing surface friction or drag in comparison with the same surface without flow control apparatus.

33. A method of controlling fluid flow according to claim 23, in which said blades are mounted extending substantially directly away from said surface.

34. A boundary layer flow control apparatus according to claim 30, in which said blades are mounted extending substantially directly away from said surface.

35. A method of controlling fluid flow according to claim 23, in which said blades are selected from the group consisting of: (a) configured as flat plate elements; (b) generally rectangular; (c) generally parallel; (d) generally of uniform height; (e) generally of uniform width; (f) generally of uniform chord; (g) generally of uniform spacing; (h) generally of uniform orientation; (i) generally uniform dimensions; and 0) dimensions vary across a surface.

36. A boundary layer flow control apparatus according to claim 30, in which said blades are selected from the group consisting of: (a) configured as flat plate elements; (b) generally rectangular; (c) generally parallel; (d) generally of uniform height; (e) generally of uniform width; (f) generally of uniform chord; (g) generally of uniform spacing; (h) generally of uniform orientation; (i) generally uniform dimensions; and (0) dimensions vary across a surface.

37. A method of controlling fluid flow according to claim 23, in which said blades project into said boundary layer by 100 to 200 wall units.

38. A boundary layer flow control apparatus according to claim 30, in which said blades project into said boundary layer by 100 to 200 wall units.

39. A method of controlling fluid flow according to claim 23, in which said blade orientation can be adjusted relative to the direction of fluid flow.

40. A boundary layer flow control apparatus according to claim 30, in which said blade orientation can be adjusted relative to the direction of fluid flow.

41. A method of controlling fluid flow according to claim 23, in which said blades are arranged as an array of multiple repeated rows.

42. A boundary layer flow control apparatus according to claim 30, in which said blades are arranged as an array of multiple repeated rows.

43. A method of controlling fluid flow according to claim 23, in which said blades have a height, width and chord ratio of X:Y:Z wherein X is between 1 and 6, Y is between 1 and 6 and Z is between 1 and 6.

44. A boundary layer flow control apparatus according to claim 30, in which said blades have a height, width and chord ratio of X:Y:Z wherein X is between 1 and 6, Y is between 1 and 6 and Z is between 1 and 6.

45. A method of controlling fluid flow according to claim 29 in which at least a 2% improvement in one or more selected from the group consisting of:
a) reduction of surface drag;
b) reduction of noise levels;
c) reduction of fuel consumption; and
d) increased speed; is observed compared to a vehicle, including an aircraft, without said flow manipulator blades projecting from said fluid contacting surface.

46. A method of controlling fluid flow according to claim 29 in which at least a 5% improvement in one or more selected from the group consisting of:
a) reduction of surface drag;
b) reduction of noise levels;
c) reduction of fuel consumption; and
d) increased speed; is observed compared to a vehicle, including an aircraft, without said flow manipulator blades projecting from said fluid contacting surface.

47. A method of controlling fluid flow according to claim 29 in which at least a 10% improvement in one or more selected from the group consisting of:
e) reduction of surface drag;
f) reduction of noise levels;
g) reduction of fuel consumption; and
h) increased speed; is observed compared to a vehicle, including an aircraft, without said flow manipulator blades projecting from said fluid contacting surface.

48. A method of controlling fluid flow according to claim 29 in which at least a 15% improvement in one or more selected from the group consisting of:
i) reduction of surface drag;
j) reduction of noise levels;
k) reduction of fuel consumption; and
l) increased speed; is observed compared to a vehicle, including an aircraft, without said flow manipulator blades projecting from said fluid contacting surface.

49. A surface upon which is mounted a boundary layer flow control apparatus according to claim 30.

50. An aircraft, with body, wing and tail sections, with boundary layer flow control apparatus as claimed in claim 30 mounted upon the body, wing and/or tail section.

51. A pipe with an internal surface upon which is mounted boundary layer flow control apparatus as claimed in claim 30.

52. A method of reducing the surface drag of an aircraft having an outer surface skin comprising affixing a large number, preferably at least five hundred, of flow manipulator control blades to the surface skin, said blades being aligned with the expected direction of fluid flow past said aircraft skin.

53. A method of reducing the surface drag in a pipe or conduit having an inner surface comprising affixing flow manipulator control blades to said inner surface, said blades being aligned with the expected direction of fluid flow past the surface.
